(19) United States
(12) Patent Application Publication
(10) Pub. No.: US 2009/0073614 A1
(43) Pub. Date: Mar. 19, 2009

(54) Voice Coil Motor

(76) Inventors: Chao Bi, Singapore (SG); Quan Jiang, Singapore (SG); Song Ling, Singapore (SG)

Correspondence Address: JACOBSON HOLMAN PLLC, 400 SEVENTH STREET N.W., SUITE 600, WASHINGTON, DC, 20004, US

(21) Appl. No.: 12/226,673

(22) PCT Filed: Apr. 26, 2006
(86) PCT No.: PCT/SG2006/000105

§ 371 Date: Oct. 24, 2008

(51) Int. Cl. G11B 5/55

(52) U.S. Cl. 360/256.2; 360/264.9; G9B/5.187

(57) ABSTRACT

A voice coil motor has an arm for arcuate movement about a pivot, and a coil at one end of the arm. There is a permanent magnet mounted adjacent the coil. The permanent magnet has only one pole facing, and for operational co-operation with, the coil. The coil has a centre of mass and a geometric centre. The center of mass and the geometric centre are coincident. The coil is mounted to the arm perpendicular to a movement plane of the arm for the arcuate movement.

### FIELD OF THE INVENTION

This invention relates to a voice coil motor and refers particularly, though not exclusively, to a rotary voice coil motor of improved construction.

### BACKGROUND OF THE INVENTION

FIGS. 1 to 5 show the structure of a traditional voice coil motor as used in hard disk drives. Its electromagnetic parts are formed by a coil 101; a permanent magnet 102 with two permanent magnet blocks 103 and 104; two yokes 105, 106; and an arm 107. The coil 101 is mounted to the arm 107 in the plane of movement of the arm 107 of the voice coil motor. The coil 101 has two sides 108 and 109 that are the effective sides in generating electromagnetic torque. The ends 110, 111 are used to connect the wires of the winding to form closed current loops of the coil 101.

The magnet 102 is arranged in pole pairs 103, 104. During operation the effective side 108 of the winding 101 is always over the same magnetic pole 103, and the other effective side 109 is always over the other magnetic pole 104. The two blocks of magnets 103, 104 produce opposite magnetic fields in the air gap between the permanent magnet 102 and the coil 101.

A field interval 112 between the north and south poles 103, 104 is unavoidable in the magnet 102 of the traditional rotary voice coil motor. Therefore, the permanent magnet 102 cannot be used efficiently. This increases the volume of the voice coil motor. Another problem caused by the interval 112 is that the magnetic field in the air gap varies. This may cause the torque constant of the voice coil motor to vary at different positions. The variation of the torque constant makes control difficult in hard disk drive operation.

When the current passes through the winding 101 both the effective sides 108, 109 are acted on by the electromagnetic forces, and the electromagnetic forces drive the voice coil motor arm 107 to rotate in an arcuate manner around the pivot 113, with the extent of movement being the distance D. Besides the electromagnetic forces acting on the effective sides 108, 109 there are also electromagnetic forces acting on the ends 110, 111. The value and direction of the electromagnetic force acting on ends 110, 111 vary during the operation of the voice coil motor. This induces vibration in the arm 107, and other components.

### SUMMARY OF THE INVENTION

In accordance with a first preferred aspect there is provided a voice coil motor comprising an arm for arcuate movement about a pivot and a coil at one end of the arm. A permanent magnet is mounted adjacent the coil. The permanent magnet has only one pole facing, and for operational co-operation with, the coil.

The coil may be mounted to the arm in a plane perpendicular to a movement plane of the arm for the arcuate movement.

In accordance with a second preferred aspect there is provided a voice coil motor comprising an arm for arcuate movement about a pivot, and a coil at one end of the arm. The coil has a centre of mass and a geometric centre. The center of mass and the geometric centre are coincident.

In accordance with a third preferred aspect there is provided a voice coil motor comprising an arm for arcuate movement about a pivot, and a coil at one end of the arm. The coil is mounted to the arm perpendicular to a movement plane of the arm for the arcuate movement.

For the first and third aspects the coil may have a centre of mass and a geometric centre, the centre of mass and the geometric centre being coincident. For all aspects, the one end of the arm may be bifurcated. The coil may comprise a first portion attached to a first arm portion, and a second portion attached to a second arm portion, the first arm portion and the first portion being at an included angle to the second arm portion and the second portion. The included angle may be in the range of 30° to 1800. The first arm portion and the second arm portion may be co-linear. The first portion and the second portion may be identical. The first portion and the second portion may be operatively connected by an intermediate portion, the coil being generally U-shaped.

The permanent magnet may have a left portion and a right portion with a gap between the left portion and the right portion, the arcuate movement of the arm being within the gap and between the left portion and the right portion.

The coil may be mounted in a groove in a lower surface of the one end of the arm. The coil may have a single effective side facing the permanent magnet. The coil may have an upper effective side vertically above the single effective side. There may be an opening between the single effective side and upper effective side. The permanent magnet may be mounted on a bottom yoke. There may be a top yoke passing through the opening. The single effective side and the upper effective side may be joined by ends. The single effective side, the upper effective side and the ends may define therebetween the opening.

### BRIEF DESCRIPTION OF THE DRAWINGS

In order that the present invention may be fully understood and readily put into practical effect, there shall now be described by way of non-limitative example only preferred embodiments of the present invention, the description being with reference to the accompanying illustrative drawings.

In the drawings:

FIG. 1 is a top perspective view of a prior art voice coil motor;

FIG. 2 is a perspective view of the coil of FIG. 1;

FIG. 3 is a perspective view of the permanent magnet of FIG. 1;

FIG. 4 is a view of the prior art voice coil motor of FIG. 1 with the top yoke removed;

FIG. 5 is a graph of the magnetic field in the air gap for the prior art voice coil motor of FIG. 1 to 4;

FIG. 6 is a perspective view of a first preferred embodiment;

FIG. 7 is a perspective view of a coil according to the first preferred embodiment;

FIG. 8 is an end view of the embodiment of FIG. 6;

FIG. 9 is an illustration of a part of the permanent magnet of the first preferred embodiment on an enlarged scale;

FIG. 10 is a graph of the magnetic field in the air gap of the first preferred embodiment;

FIG. 11 is an illustration of a second preferred embodiment;

FIG. 12 is an illustration of a third preferred embodiment;

FIG. 13 is an illustration of a fourth preferred embodiment; and

FIG. 14 is an illustration of a further preferred embodiment.

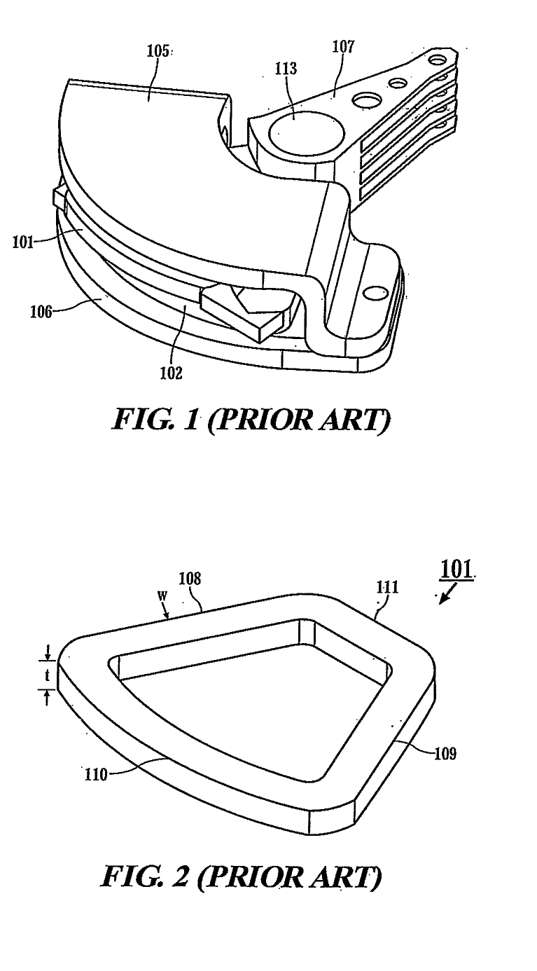

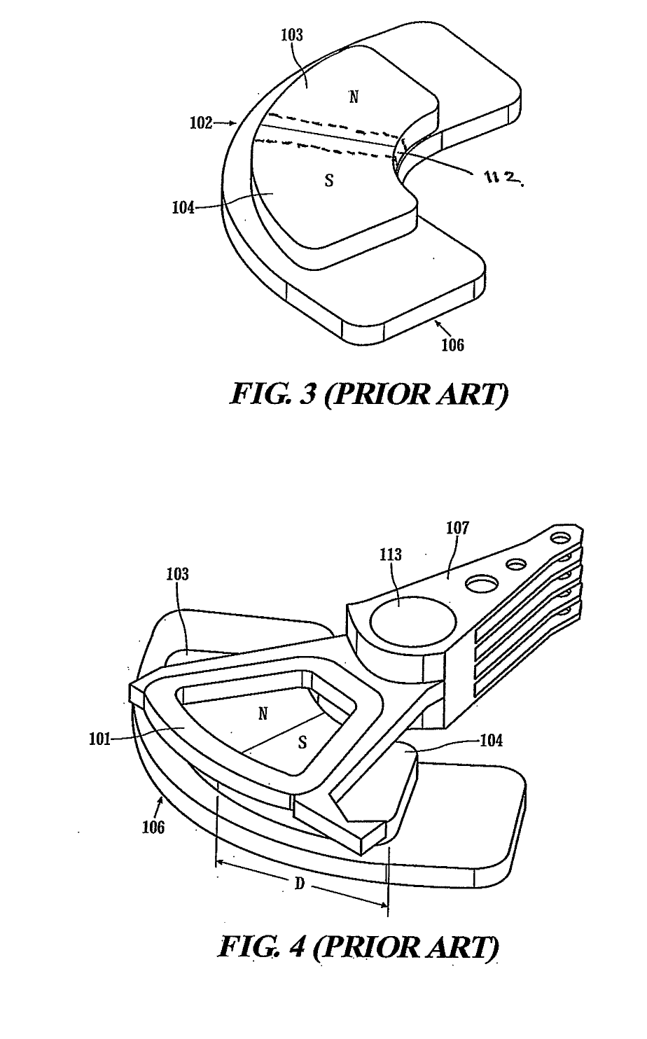

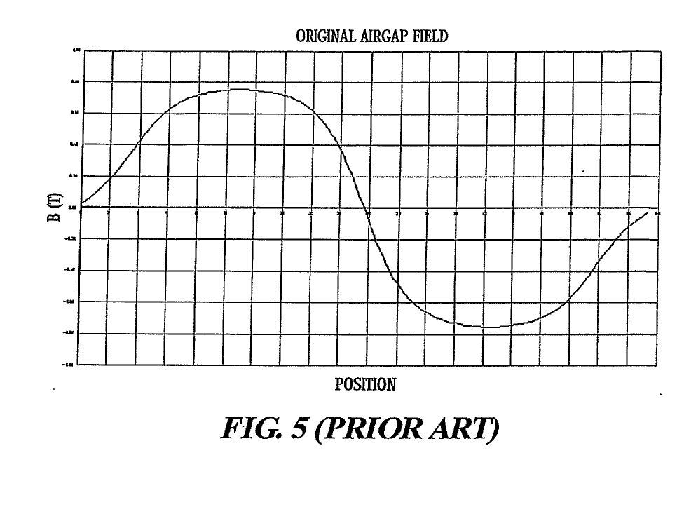

### DETAILED DESCRIPTION OF THE PREFERRED EMBODIMENTS

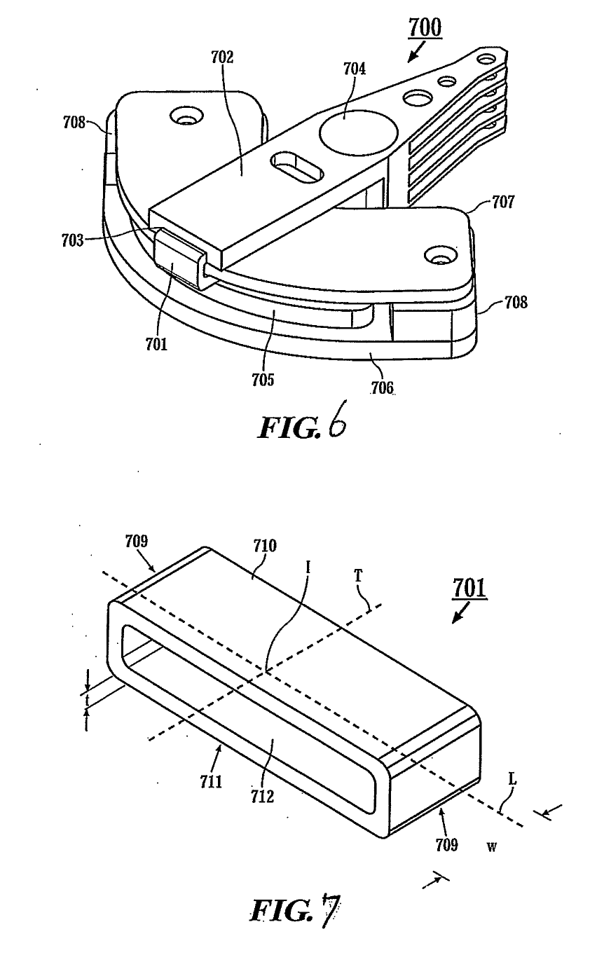

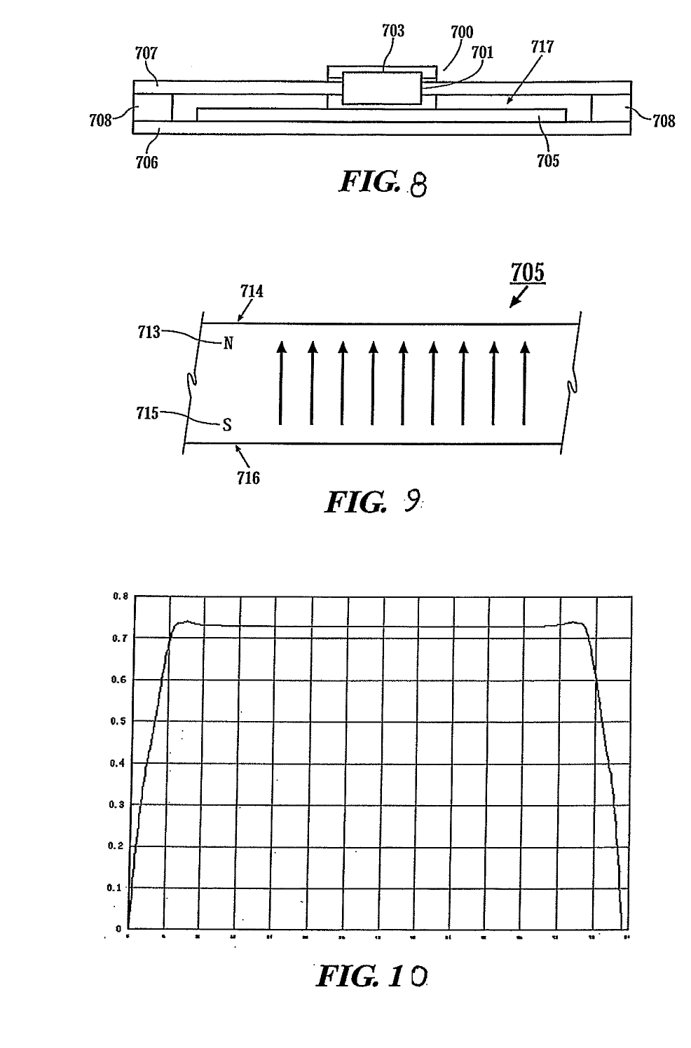

To refer to FIGS. 6 to 9 there is shown a preferred embodiment having an arm 700 with a coil 701 at one end 702 thereof. The coil 701 is mounted in a slot 703 in the end 702 of arm 700. Alternatively, it may be adhered to the end 702 of arm 700.

The arm 700 is mounted for arcuate movement about a pivot 704 so that end 702 and thus coil 701 move in a movement plane that is parallel to and above a permanent magnet 705. Permanent magnet 705 is mounted on a bottom yoke 706, with end blocks 708 and top yoke 707 completing the basic structure.

The coil 701 has ends 709, an upper effective side 710 and a lower effective side 711. The two ends 709 and the effective sides 710, 711 define an opening 712. As can be seen, the coil is symmetrical about its longitudinal central axis L, and its transverse central axis T. The intersection I of the longitudinal central axis L and the transverse central axis T is the geometric centre of the coil 701, and is the geometric centre of opening 712. In this case, the geometric centre at I is also the centre of mass of the coil 701.

The coil 701 is arranged on arm 700 in a manner that has it aligned perpendicularly to the plane of movement of arm 700. This is with upper effective side 710 vertically above and aligned with lower effective side 711. The arm 700 moves arcuately about the pivot 704.

The permanent magnet 705 is arranged so that one pole 713 is at and/or adjacent the upper surface 714 of the permanent magnet, and the other pole 715 is at and/or adjacent the lower surface 716. The lower surface 716 is mounted on bottom yoke 706. In this way, a single pole 713 of the permanent magnet 705 faces the air gap 717, and thus the lower effective side 711 of the coil 701, over the entire upper surface 714 of the permanent magnet 705. This avoids the interval 112 between the magnetic poles 103, 104 interfering with the operation of the voice coil motor as the interval between the pole 713, 715 is approximately the middle of the height of the permanent magnet 705. It therefore has no effect on the coil 701. This also means the permanent magnet 705 can be made smaller, thus reducing the distance between the end blocks 708. The end blocks 708 are preferably made of a magnetic material, such as a ferro-magnetic material and may be of the same material as the bottom and top yokes 706 and 707. It also means a single effective side (the lower effective side 711) faces the air gap 717 and thus the permanent magnet 705, particularly the single pole 713 of the permanent magnet 705. In consequence, the single effective side 711 operatively co-operates with the single pole 713.

As can be seen, the top yoke 707 passes through the opening 712 and thus between the upper effective side 710 and the lower effective side 711.

This means the magnetic field in the air gap has the shape shown in FIG. 10. The uniformity of the magnetic field, and the uniformity of the frequency of the alternating current in the coil 701, provides an improved stability of operation and reduced vibration. Also, the uniformity of the magnetic field provides a more stable torque constant for the voice coil motor.

By comparing the coil 701 of FIG. 6 with the coil 101 of FIG. 2, it can be seen that the width W of the effective side 711 of FIG. 6 is greater than the width of the effective side 108 of FIG. 2. As such, the thickness t of the effective side 711 (and thus for the entire coil) is able to be reduced over the thickness t of the effective side 108, and thus all of coil 101.

Furthermore, the height of air gap 717—the distance between upper surface 714 of the permanent magnet and the lower surface of top yoke 707—is able to be reduced due to the reduced thickness of the coil 701. Therefore, for a permanent magnet of the same thickness, the magnetic field in the air gap can be increased, and the coil 701 requires fewer coil turns to achieve the same torque constant.

Furthermore, as the geometric and mass centres of coil 701 are coincident the rotational inertia is reduced. The coil 101, due to its shape, has its centre of mass closer to end 110 than end 111. The rotational inertia is the product of the mass and the square of the distance of the mass from the pivot 113, 704. As the centre of mass of coil 701 is coincident with its geometric centre, the centre of mass of coil 701 is closer to pivot 704 than the centre of mass of coil 101 is from pivot 113. Therefore, if coils 701, 101 were of the same mass the rotational inertia of coil 701 would be less than that of coil 101.

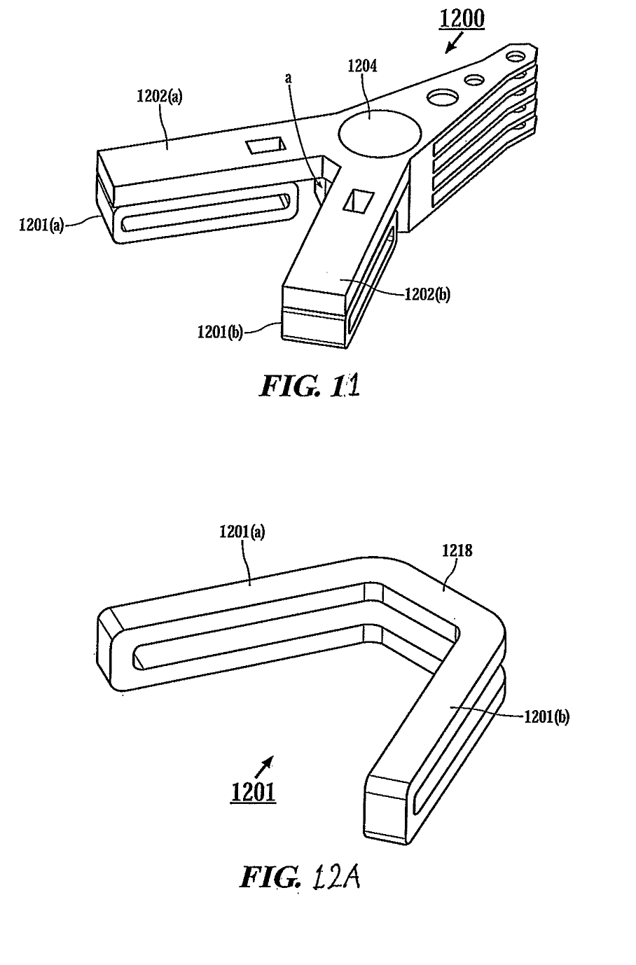

FIG. 11 shows a second preferred embodiment. Here, the arm 1200 is bifurcated to form two identical arm portions 1202 (a) and (b) separated by an included angle a that is in the range of 30° to 900, but preferably is 450 to 60°. This makes the voice motor design more flexible, and the space in the hard disk drive may be used more efficiently.

The coil 1201 is in two portions with each arm 1202 (a), (b) having an identical portion 1201(a), (b), as before.

In FIG. 12, the two coils 1201 are joined by an intermediate portion 1218 so that the coils 1201(a), 1201(b) and intermediate portion 1218 form a single, U-shaped coil 1201.

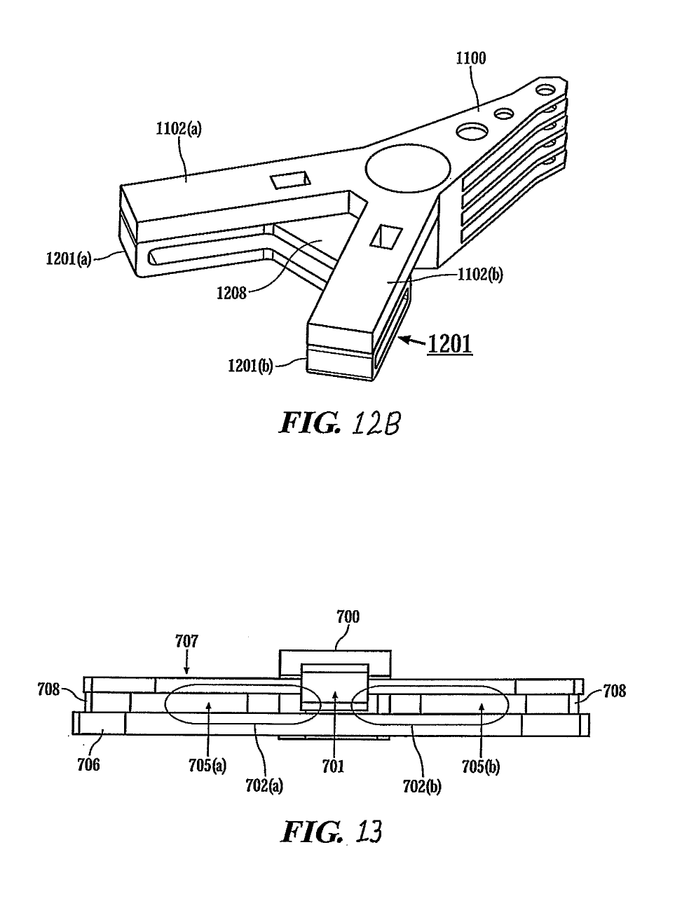

FIG. 13 shows an embodiment where the permanent magnet 705 is split into two portions—a left portion 705(a) and a right portion 705 (b). The arm 700 and thus the coil 701 will move between the portions 705(a) and (b). This structure provides a voice coil motor of reduced height. The two magnetic paths 720(a) and (b) are as shown—the bottom yoke 706, top yoke 707, coil 701 and magnets 705(a) and (b) respectively.

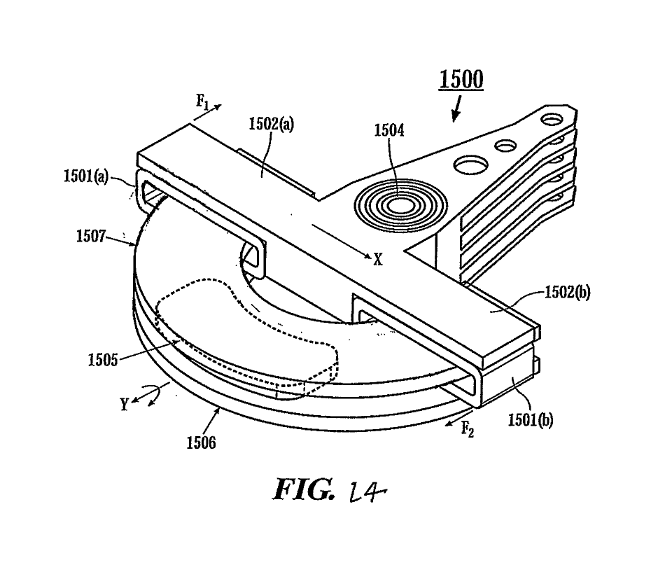

FIG. 14 is a variation of that of FIG. 11 with top yoke 1507 being shown in relief. Here, the included angle between arm portion 1502(a) and (b) is 180° so that the two arm portions 1502(a) and (b) are co-linear. A current applied to coils 1501(a) and (b) will induce forces F₁ and F₂. As the current to the coils 1501(a) and (b) is the same and the coils 1501(a) and (b) are the same, F₁=F₂. Therefore, the net force acting on pivot 1504 is zero. As such, the arm 1500 has acting on it at pivot 1504 only a torque. This will substantially eliminate a cause of disturbances (e.g. vibration) to arm 1500 and thus voice coil motor.

As the length of the two arm portions 1502(a) and (b) in the X direction is increased, the rotational inertia around the axis Y is increased, thus reducing movement, or a tendency to movement, around the axis Y, thereby allowing an increased bandwidth of the voice coil motor.

Whilst there has been described in the foregoing description preferred embodiments of the present invention, it will be understood by those skilled in the technology concerned that many variations or modifications in details of design or construction may be made without departing from the present invention.

1. A voice coil motor comprising:
(a) an arm for arcuate movement about a pivot;
(b) a coil at one end of the arm;
(c) a permanent magnet mounted adjacent said coil;
(d) the permanent magnet having only one pole facing, and for operational co-operation with, the coil.

2. A voice coil motor comprising:
(a) an arm for arcuate movement about a pivot;
(b) a coil at one end of the arm, the coil having a centre of mass and a geometric centre;
(c) the center of mass and the geometric centre being coincident.

3. A voice coil motor comprising:
(a) an arm for arcuate movement about a pivot;
(b) a coil at one end of the arm;
(c) the coil being mounted to the arm perpendicular to a movement plane of the arm for the arcuate movement.

4. A voice coil motor as claimed in claim 1, wherein the coil is mounted to the arm in a plane perpendicular to a movement plane of the arm for the arcuate movement.

5. A voice coil motor as claimed in claim 1, claim 3 or claim 4 wherein the coil has a centre of mass and a geometric centre, the centre of mass and the geometric centre being coincident.

6. A voice coil motor as claimed in any one of claims 1 to 5, wherein the one end of the arm is bifurcated, the coil comprising a first portion attached to a first arm portion, and a second portion attached to a second arm portion, the first arm portion and the first portion being at an included angle to the second arm portion and the second portion.

7. A voice coil motor as claimed in claim 6, wherein the included angle is in the range of 30° to 180°.

8. A voice coil motor as claimed in claim 6 in claim 7, wherein the first arm portion and the second arm portion are co-linear.

9. A voice coil motor as claimed in any one of claims 6 to 8, wherein the first portion and the second portion are identical.

10. A voice coil motor as claimed in any one of claims 6 to 9, wherein the first portion and the second portion are operatively connected by an intermediate portion, the coil being generally U-shaped.

11. A voice coil motor as claimed in claim 1 or any one of claim 4 to 10 when appended to claim 1, wherein the permanent magnet has a left portion and a right portion with a gap between the left portion and the right portion, the arcuate movement of the arm being within the gap and between the left portion and the right portion.

12. A voice coil motor as claimed in any one of claims 1 to 11, wherein the coil is mounted in a groove in a lower surface of the one end of the arm.

13. A voice coil motor as claimed in claim 1 or any one of claims 4 to 12, wherein the coil has a single effective side facing the permanent magnet.

14. A voice coil motor as claimed in claim 13, wherein the coil further comprises an upper effective side vertically above the single effective side.

15. A voice coil motor as claimed in claim 14, wherein there is an opening between the single effective side and the upper effective side.

16. A voice coil motor as claimed in claim 15, wherein the upper effective side and the single effective side are joined by ends; the upper effective side, the single effective side and the ends defining therebetween the opening.

17. A voice coil motor as claimed in any one of claims 1 to 6, wherein the permanent magnet is mounted on a bottom yoke.

18. A voice coil motor as claimed in any one of claims 15 to 17 further comprising a top yoke passing through the opening.
